(19) United States
(12) Patent Application Publication
(10) Pub. No.: US 2017/0072737 A1
(43) Pub. Date: Mar. 16, 2017

(54) SYSTEM AND METHOD FOR LABELING GLOVES

(71) Applicant: Nick Santana, Palmdale, CA (US)

(72) Inventor: Nick Santana, Palmdale, CA (US)

(21) Appl. No.: 15/262,292

(22) Filed: Sep. 12, 2016

Related U.S. Application Data
(60) Provisional application No. 62/217,204, filed on Sep. 11, 2015.

(51) Int. Cl. B44C 1/17; A41D 19/00

(52) U.S. Cl. CPC B44C 1/1712; A41D 19/0051; A41D 19/0082; A41D 2400/52

(57) ABSTRACT

According to an exemplary embodiment, a method for affixing a decorative element to a disposable glove may be provided. A decorative element may be provided for application on the glove. The decorative element may be printed on a suitable printing substrate. The substrate may then be placed against a designated area on the surface of the glove with the printed decorative element disposed between the substrate and designated area. The glove may be disposed on a rigid supporting member, providing a backing for the application of the decorative element. The decorative element may then be transferred from the substrate to a designated area on the surface of the supported glove.

### PRIORITY CLAIM

This application claims priority to U.S. provisional patent application No. 62/217,204, filed Sep. 11, 2015, the contents of which are hereby incorporated by reference in their entirety.

### BACKGROUND

Gloves have been utilized by humans for an immeasurable variety of uses. The development of polymer-based gloves has further increased the uses of gloves, including disposable gloves. The uses of such gloves range from medical applications and food preparation to automotive and machine applications. Given the variety of applications, a great number of businesses utilize gloves in their operations. The immense number of gloves used by these businesses present a potential advertising platform, however, this platform has failed to materialize due to the difficulty in efficiently applying logos to these polymer-based gloves without negatively impacting the desired structure and qualities of the gloves.

### SUMMARY

According to an exemplary embodiment, a method for affixing a decorative element to a disposable glove may be provided. A decorative element may be provided for application on the glove. The decorative element may be printed on a suitable printing substrate. The substrate may then be placed against a designated area on the surface of the glove with the printed decorative element disposed between the substrate and designated area. The glove may be disposed on a rigid supporting member, providing a backing for the application of the decorative element. The decorative element may then be transferred from the substrate to a designated area on the surface of the supported glove. Additionally, the method may further include the steps of drying the substrate imprinted with the decorative element, and drying the glove containing the transferred decorative element.

In accordance with another exemplary embodiment, the process of printing the decorative element on the substrate may be dye-sublimation printing. The ink used in the printing process may be a solvent ink that facilitates bonding to elastomeric material of the glove. The process of transferring the decorative element from the substrate to the surface of the glove may be accomplished via heat applied pressure. The rigid supporting member securing the glove during the transfer may be configured to improve heat dissipation and prevent melting of the glove.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a flow chart illustrating a method for the fabrication of a glove with decorative element in accordance to an exemplary method of the present invention;

FIG. 2 is a top view of an exemplary embodiment of a glove with decorative element; and

FIG. 3 is an exemplary embodiment of a substrate containing imprinted decorative elements.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

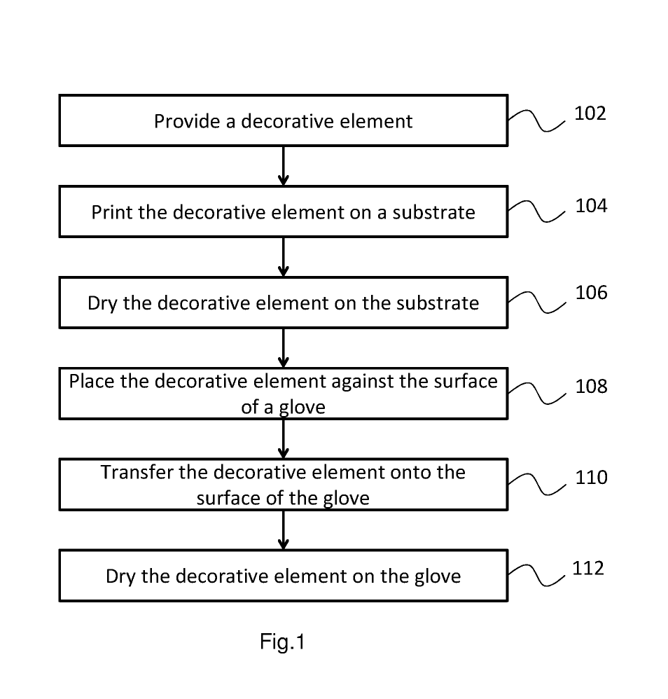

Referring to exemplary FIG. 1, a flow chart illustrating the steps of a method to fabricate a glove having an imprinted decorative element on its outer surface may be provided. In step 102, a decorative element may be provided by a customer for application on a glove. A decorative element may comprise single or multiple alphanumeric characters, symbols, emblems, images, colors, patterns or designs. In some exemplary embodiments, the decorative element may include a logo used to represent a commercial enterprise, organization or individual. The decorative element may be provided by any known method. In some exemplary embodiments, the decorative element may be electronically rendered so that computer systems can aid in the creation, modification, or optimization of the design. Alternatively, a customer may provide a decorative element in a physical medium, such as a sketch, drawing or photograph. The physical medium may then be scanned into computer memory becoming a digital-based image. In some exemplary embodiments, the computer-aided representation of the decorative element is proportionally sized to fit within a designated printing area on the surface of the glove.

In step 104, the decorative element may be printed on any suitable printing substrate. Printing may be accomplished through any known technique. In an exemplary embodiment, the printing process employs dye-sublimation printing. A dye-sublimation printer may be communicatively coupled to computer software or memory containing the decorative element data. Once the desired decorative element is selected from the computer, image data may be sent to the dye-sublimation printer. In some exemplary embodiments, the image may be plotted using CAD technology. During the printing process, a special-formulated solvent ink, which begins in a solid state, sublimates to a gas state upon the application of heat through a piezoelectric print head. The ink is subsequently cooled and may be absorbed or transferred to a sheet of transfer release paper. The dye-sublimation printer lays one color at a time, storing each color on a separate printer panel before use. During the printing cycle, the printer may manipulate both the transfer release paper and one of the colored panels together under the thermal printing head. After the printer finishes depositing the ink in one color, it may move on to the next color, until the entire digital image is replicated on the transfer release paper. In some exemplary embodiments, the decorative element may optionally be printed onto the substrate using heat glue.

In step 106, the substrate containing the printed decorative element may be dried, as would be understood by a person having ordinary skill in the art. In step 108, the printed decorative element on the substrate may be placed against a glove in any desired orientation. The substrate may be positioned such that the printed decorative element may be disposed between the substrate and an outer surface of the glove. In an exemplary embodiment, the glove is disposed on a rigid supporting member. The rigid supporting member may allow the decorative element to be applied to the glove with pressure. The right supporting member may be sized and shaped to at least fill a glove proximate a desired placement location. Alternatively, the rigid supporting member may be slightly larger in size than the glove and configured to attach to an additional fixture. In some exemplary embodiments, the rigid supporting member may be comprised of aluminum and have a substantially rectangular shape. At least a portion of the rigid supporting member may be waffled. The waffling may improve heat dissipation via the ridges and sections of waffling and act to prevent melting of the glove during the heat transfer phase. Further, the waffling can allow for the glove to maintain its structure and characteristics during the heat transfer phase. For example, the impermeability of the glove may be maintained so that the heat transfer does not deteriorate any portion of the glove.

Once positioned against the glove, the decorative element may be transferred from the substrate to the glove's outer surface as provided in step 110. In some exemplary embodiments, the transfer process may be accomplished via heat transfer of the ink from the substrate to a receiving surface on the glove. The heat transfer may be effectuated by a heat press operating at a temperature of about 165 degrees Celsius. In some exemplary embodiments, the heat transfer process is automated. The heat press may operate to automatically press down on the imprinted substrate, positioned against the glove, at predetermined intervals. Remaining transfer paper may optionally be removed after the heat transfer is complete. In step 112, the glove, now infused with dye, may be dried.

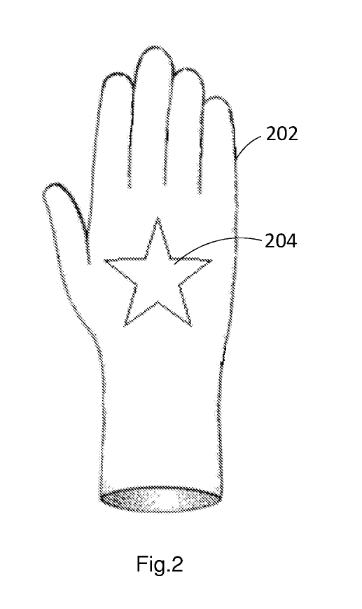

Referring to exemplary FIG. 2, an embodiment of a glove with decorative element may be provided. A glove 202 may be any type of glove, including disposable and non-disposable gloves, as would be understood by a person having ordinary skill in the art. Glove 202 may be made from any of a plurality of materials, either alone or in combination. In some exemplary embodiments, glove 202 may be formed of a substantially non-porous and fluid impervious elastomeric material, such as rubber, latex, nitrile, vinyl and neoprene, or any combination thereof. Decorative element 204 may be displayed on any and all areas of the glove's outer surface, including but not limited to, the palm, thumb, finger, wrist, and back of hand (as is shown in FIG. 2). The decorative element 204 may be one continuous design or may alternatively be dispersed throughout the glove's surface. Additionally, as described above, the application or maintenance of the decorative element on the glove may not diminish any of the properties or the glove or otherwise adversely affect its performance or use.

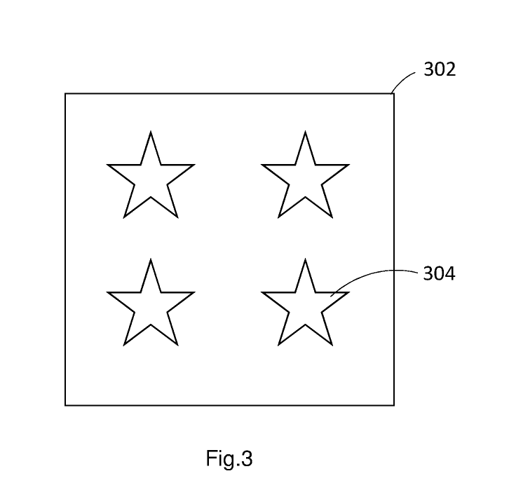

Referring to exemplary FIG. 3, an embodiment of a substrate containing imprinted decorative elements may be provided. A substrate 302 may be any known medium which allows for the transfer of ink to a corresponding glove. In an exemplary embodiment, the substrate is a clear cellophane material. Decorative element 304 may be transferred on the substrate 302 through any known method. In an exemplary embodiment, decorative element 304 is printed on the substrate 302 via dye-sublimation, and die cut via an automated CAD plotter. In some embodiments, the decorative element may optionally be printed on the substrate in a mirrored orientation. This may cause the logo to appear in a non-mirrored orientation when viewed on a glove.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of affixing a decorative element to a disposable glove, comprising the steps of:
providing the decorative element for application on the glove;
printing the decorative element on a substrate;
securing the glove to a rigid supporting member; and
transferring the decorative element from the substrate to a designated area on the surface of the secured glove.

2. The method of claim 1, wherein the providing step includes creating a computer-aided representation of the decorative element.

3. The method of claim 1, wherein the transferring step includes placing the substrate against the designated area with the printed decorative element disposed between the substrate and designated area.

4. The method of claim 1, wherein the process of transferring the decorative element from the substrate to the glove is a heat applied transfer process.

5. The method of claim 4, wherein the heat applied transfer process is effectuated by a heat press.

6. The method of claim 5, wherein the process of heat applied transfer is carried out at a temperature of 165 degrees Celsius.

7. The method of claim 1, wherein the rigid supporting member is composed of aluminum.

8. The method of claim 7, wherein the rigid supporting member has a substantially rectangular shape.

9. The method of claim 8, wherein a length of the rigid supporting member is larger than a length of the glove.

10. The method of claim 1, wherein at least a portion of the rigid supporting member is waffled.

11. The method of claim 1, wherein the substrate is a clear cellophane material.

12. The method of claim 2, wherein the computer-aided representation of the decorative element is proportionally sized to fit within the designated area on the surface of the glove.

13. The method of claim 1, wherein the glove is formed of a substantially non-porous and fluid impervious elastomeric material.

14. The method of claim 13, wherein the elastomeric material comprises at least one of rubber, latex, nitrile, vinyl and neoprene.

15. The method of claim 13, wherein the printing step includes the use of a solvent ink which facilitates bonding to the elastomeric material.

16. The method of claim 1, wherein the process of printing the decorative element on the substrate is dye-sublimation printing.

17. The method of claim 1, further comprising the step of drying the substrate imprinted with the decorative element.

18. The method of claim 1, further comprising the step of drying the glove containing the transferred decorative element.
